(19) United States
(12) Patent Application Publication
(10) Pub. No.: US 2010/0207358 A1
(43) Pub. Date: Aug. 19, 2010

(54) LASER GUIDED TOWING HITCH ALIGNMENT SYSTEM

(76) Inventor: Christopher Ryder, Chelmsford, MA (US)

Correspondence Address: ELMORE PATENT LAW GROUP, PC, 515 Groton Road, Unit 1R, Westford, MA, 01886, US

(21) Appl. No.: 12/621,017

(22) Filed: Nov. 18, 2009

Related U.S. Application Data
(60) Provisional application No. 61/115,734, filed on Nov. 18, 2008.
(60) Provisional application No. 61/164,777, filed on Mar. 30, 2009.

(51) Int. Cl. B60D 1/36

(52) U.S. Cl. 280/477

(57) ABSTRACT

This invention relates to a device that assists a user in positioning a tow vehicle next to a trailer such that the hitch component affixed to the tow vehicle aligns properly with, and connects easily to, the hitch component affixed to the trailer. This invention particularly relates to a laser guided alignment apparatus that aligns a hitch component mounted on a tow vehicle to a trailer with either a bumper ball or gooseneck hitch.

### RELATED APPLICATIONS

This application claims the benefit of U.S. Provisional Application No. 61/115,734, filed on Nov. 18, 2008 and 61/164,777, filed on Mar. 30, 2009. The entire teachings of the above applications are incorporated herein by reference.

### BACKGROUND OF THE INVENTION

There are several widely available hitching mechanisms used to connect a trailer to a tow vehicle, the most common types being “bumper ball” and “gooseneck.” A bumper ball hitching mechanism comprises a ball affixed to the bumper of the tow vehicle that mates or interlocks with a corresponding socket affixed to a trailer. A gooseneck hitching mechanism also uses a ball located on a tow vehicle to engage a socket mounted on the trailer; however, rather than being affixed to the bumper, the ball is mounted on the body of the tow vehicle, most commonly the bed of a truck.

Each of the aforementioned hitching mechanism designs features certain characteristics that make one more suitable than another for specific purposes. Bumper ball hitching mechanisms provide a very high degree of maneuverability and are commonly used to tow small boat trailers, small campers, utility trailers and other lighter loads with lower centers-of-gravity. Gooseneck hitching mechanisms provide a good degree of maneuverability and typically provide a higher load capacity as compared to a bumper ball type. It is not uncommon for one tow vehicle to be equipped with both hitching mechanism types; thereby accommodating the bulk of the user's towing needs.

These hitching mechanisms share a common problem related to alignment of the mating components by the user driving the tow vehicle. The user must position the tow vehicle such that the ball is located directly under the socket. Most often, both the tow vehicle and trailer mating components are not visible to the tow vehicle user and precise positioning is extremely difficult. Damage to the tow vehicle from misaligned components is very possible due to the proximity and the near-blind maneuvering.

Often, another person will act as a guide, providing verbal instructions to the tow vehicle user as he maneuvers. However, this tactic requires that another person be available to assist and raises safety concerns when lighting conditions are less than optimal as close proximity is required for the individual providing guidance to clearly see the mating components. When alone, tow vehicle users will make a rough estimate at alignment, exit the vehicle, assess where they need to maneuver, reenter the tow vehicle and make another attempt. The user may need to repeat this procedure multiple times before achieving satisfactory alignment.

Other alignment devices exist that enable a tow vehicle user to single-handedly align the mating components; however, these devices only accommodate one type of hitching mechanism, only work in daylight conditions, do not accommodate other than level ground conditions, or will not work with an angled approach by the tow vehicle.

Therefore, it is an object of the present invention to provide a laser guided alignment device that will allow a user to single-handedly align the mating components of a hitching mechanism that are respectively affixed to a tow vehicle and a trailer. It is also an object of the present invention to provide the desired functionality in both daylight and darkness, on varying grades and at varying approach angles.

### SUMMARY OF THE INVENTION

The present invention is an adjustable, removable, portable, collapsible or foldable, and optionally, self-leveling apparatus used to align two-part mating hitch components such as those found on bumper ball and gooseneck hitching systems. The apparatus comprises a light emitting device that emits an easily seen beam of light onto a target. The light emitting device mounts on or near the hitch component affixed to one of the tow vehicle or trailer and emits a focused beam of light in a vertical orientation. The target mounts on or near the hitch component affixed to the other of the tow vehicle or trailer. When the beam of light appears in the center of the target surface, the hitch components are in alignment and may be mated.

To align the tow vehicle and trailer mating components, the user will first mount both the laser and the target on the hitching component of the trailer. With the light emitting device turned on, the user will adjust the target to center the beam of light on the target. The user will then relocate the light emitting device to the hitching component on the tow vehicle. The user will then maneuver the vehicle until the beam of light appears on the target surface. As the light beam is easily visible, the user may view it in a mirror or though a vehicle window. The user will continue to maneuver the vehicle until the light beam centers on the target surface. At this point, the hitching components are in proper alignment for mating.

### BRIEF DESCRIPTION OF THE DRAWINGS

The foregoing and other objects, features and advantages of the invention will be apparent from the following more particular description of the embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A and 1B show top (A) and side (B) views of the trailer and its hitch component.

FIGS. 1C and 1D show top (D) and side (C) views of the tow vehicle and its hitch component.

FIG. 2 shows the invention mounted and configured on the tow vehicle and trailer.

FIG. 3 shows the light emitting device with a self leveling gimbal ring.

FIG. 4A illustrates the self-leveling device mounted and configured on a vehicle while FIGS. 4B and 4C show expanded views of the mounting on the tow vehicle and trailer.

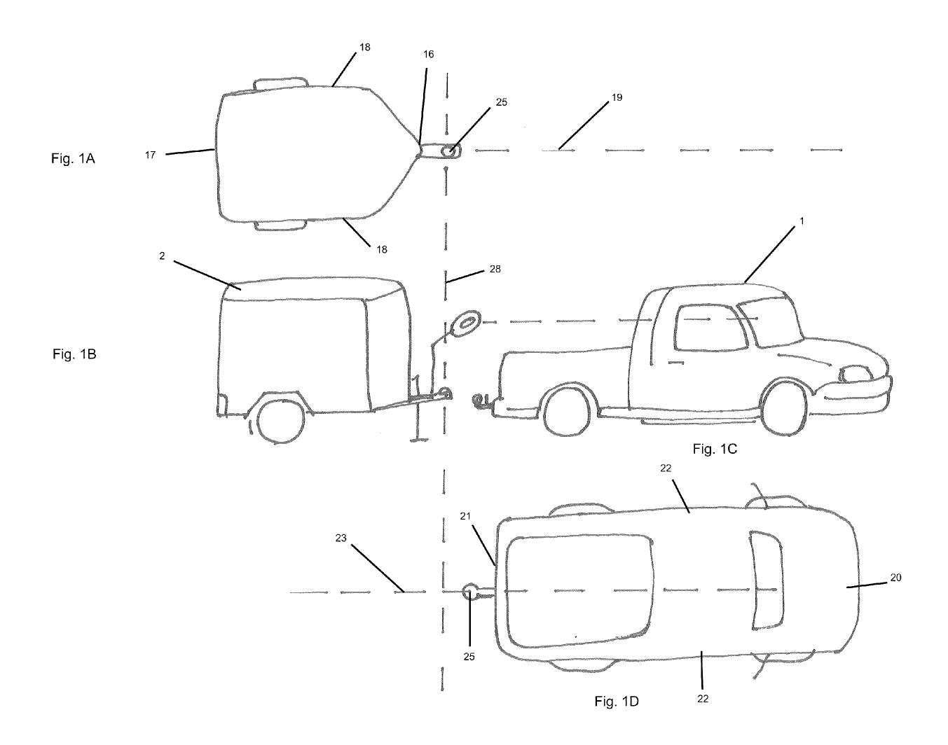

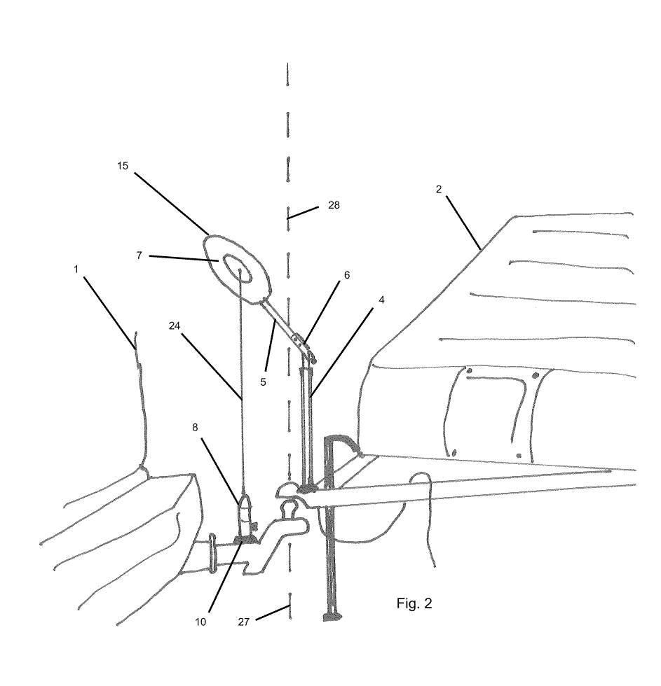

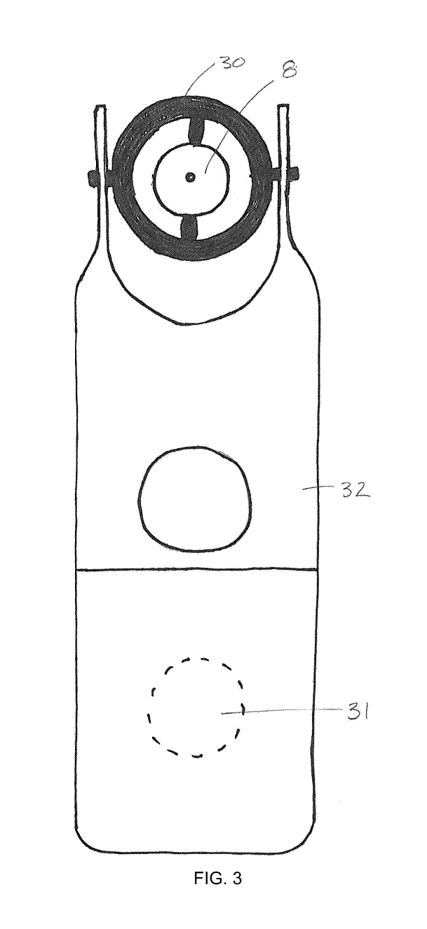

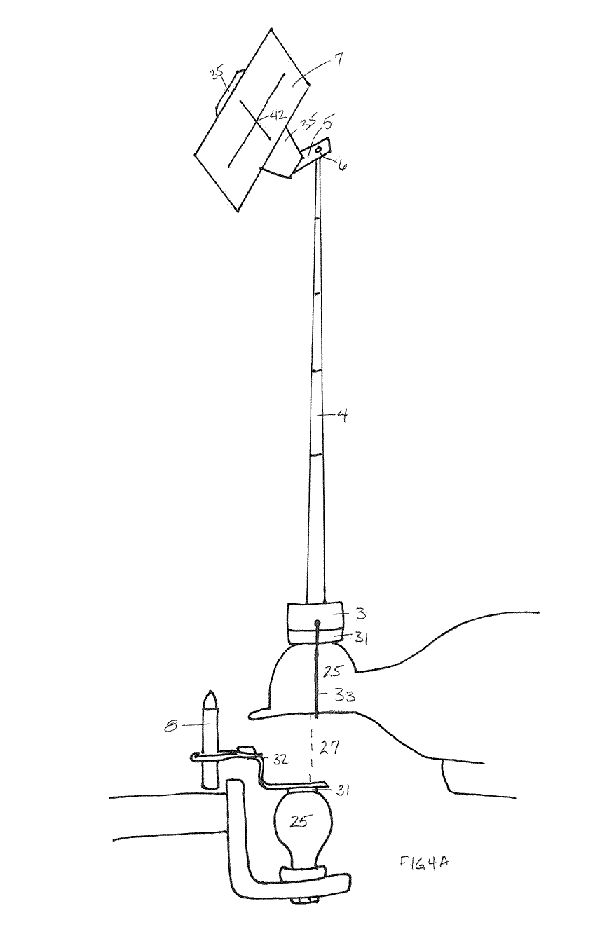

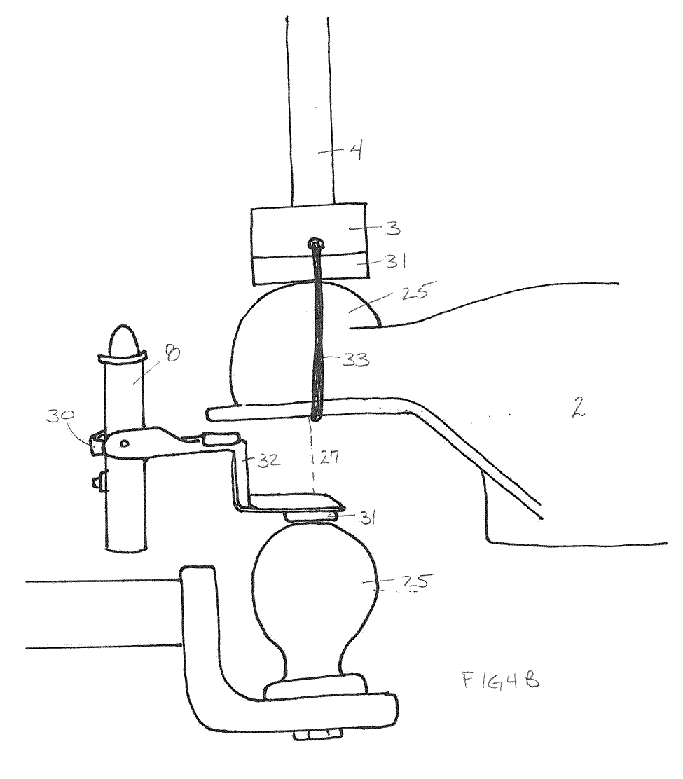

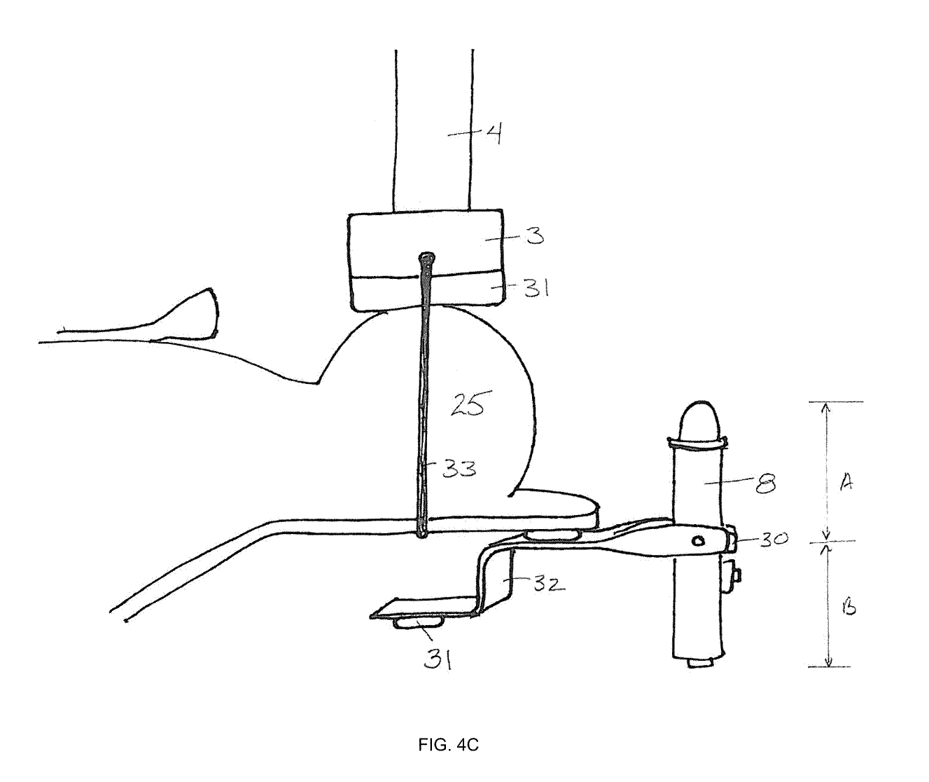

### DETAILED DESCRIPTION OF THE INVENTION

A description of the preferred embodiments of the invention follows.

The present invention is an adjustable, removable, portable, collapsible, foldable, and preferably self-leveling apparatus capable of aligning two-part mating hitch components [25] that are respectively affixed to a tow vehicle [1] and a trailer [2], such as those found on bumper ball and gooseneck hitching systems. In the case of bumper ball and gooseneck hitching mechanisms, the components [25] generally comprise a ball [11] affixed to the tow vehicle [1] that engages a socket [12] affixed to the trailer [2].

The apparatus comprises a light emitting device [8] attached to the mating component [25] or directly to the tow vehicle [1] (or trailer [2]) and a target [15] attached to the other mating component [25] of trailer [2] (or tow vehicle [1]). The light emitting device [8] comprises a light source capable of projecting a beam, such as a narrowly focused beam, of visible light [24], and, preferably, a mount [10]. The target [15] comprises: 1) a mount [3]; 2) an adjustable arm [4] affixed to the mount [3] at one end; 3) an adjustable joint [6] affixed to the end of the adjustable arm [4] opposite the mount [3]; 4) an optional second arm [5] affixed to the adjustable joint [6] at one end; and 5) a target surface [7]. The target surface [7] is affixed to the end of the optional second arm [5] opposite from the adjustable joint [6] or directly to the adjustable joint [6]. The mating component [25] of the hitching mechanism mounted on the tow vehicle [1] is aligned with the corresponding mating component [25] mounted on the trailer [2] when the beam of light [24] is centered on the target surface [7]. The target surface [7] and the beam of light [24] appearing on it are visible to a user operating the tow vehicle [1].

For descriptive purposes, the tow vehicle [1] comprises:

1. two sides [22];

2. front [20] and rear [21] ends;

3. a horizontal axis [23] that is equidistant from the two sides [22] and which passes through the center of the interlocking or mating component [25];

4. a vertical axis [27] that passes through the center of the interlocking or mating component [25]; and

5. a light emitting device [8] mounted on the horizontal axis [23] that projects a beam of light [24] substantially at a vertical right angle to it.

Similarly, the trailer [2] comprises:

1. two sides [18];

2. front [16] and rear [17] ends;

3. a horizontal axis [19] that is equidistant from the two sides [18] and which passes through the center of the interlocking or mating component [25];

4. a vertical axis [28] that passes through the center of the interlocking or mating component [25]; and

5. a target [15] mounted on the horizontal axis [19].

The light emitting device [8], preferably a laser emitting a continuous beam of light 24, is mounted to the tow vehicle [1] or mating component [25], along the horizontal axis [23] and either directly on top of, or at a known distance from, the vertical axis [27]. The device, or laser, will project a focused beam of light [24] at a determined angle, preferably a substantially vertical right angle, to the horizontal axis [23]. In a preferred embodiment, the light emitting device comprises an attaching device such as a magnet [31], suction cups, clamps, straps, adhesive, or the like which attaches and supports the light emitting device [8]. A preferred embodiment will comprise a gimbal ring [30] to enable the beam of light [24] to remain at a substantially vertical right angle to the horizontal axis [23]. This self-leveling feature may is achieved by attaching the gimbal ring [30] high up on the laser so that the bulk of its mass is below the gimbal (e.g., A<B). Alternately, the laser may be weighted if its mass or physical dimensions do not provide the leveling effect. A preferred embodiment will also comprise a bracket [32] with one or more magnets [31] that may be offset in such a manner that when mounted, the beam of light [24] is emitted a known distance away from the vertical axes [27][28] of the tow vehicle [1] or trailer [2]. A preferred embodiment will also comprise a remote control to operate the laser. The device, or laser, can be any of the widely available, inexpensive, off-the-shelf pointer lasers emitting a beam of light having a wavelength and intensity visible to the user while seated in the tow vehicle. Alternatively, the light emitting device [8] can be physically embodied in or embedded within the mating component.

The target [15] is affixed to the mating component [25] or trailer [2], along the horizontal axis [19] and either directly on top of, or at a known distance from, the vertical axis [28] of the mating component [25]. In a preferred embodiment an adjustable band is used to attach the target mount [3], providing for easy placement and removal. Suction cups, clamps, straps or the like may also be used. A preferred embodiment will also have the portion of the mount [3] that contacts the mating component [25] covered in a non-skid coating to help it maintain the desired position.

An adjustable arm [4] is affixed to the mount [3]. It preferably telescopes to allow the user to vary the height of the target [15]. In a preferred embodiment, the arm can be adjusted such that the target surface can be easily and directly viewed by the driver of the towing vehicle while operating the vehicle (e.g., through the rear window). Scribed or similar marks on the adjustable portions of the arm [4] allow a user to collapse the arm [4] and return it to the same configuration or configurations at a later time.

An adjustable joint [6] can also be affixed to the arm [4], preferably at the distal end relative to the mount [3]. A joint [6] allows a user to vary the angle and orientation of the optional second arm [5], and the target surface [7], relative to the adjustable arm [4]. The angle created by the joint between the first and second arms is selected such that the target surface [7] reflects the beam of light [24] when the mating components [25] are properly aligned. The joint [6] permits the target [15] to be collapsible or foldable to facilitate storage, and where necessary, be usable on a variety of angled surfaces. For example, the joint [6] can be set at one angle when the tow vehicle and trailer rest in the same plane (e.g., on a flat surface) or on different planes (e.g., the tow vehicle is on an incline or decline relative to the trailer). The joint can also be scribed or marked to assist in identifying the typical angles a particular user encounters.

The target further preferably comprises an optional second arm [5] affixed to the adjustable joint [6]. The arm, together with the target surface, are selected to be a length sufficient to allow the target [15] to extend over the vertical axis of the two mating components, when properly aligned and intercept the beam of light [24] when the light emitting device [8] is mounted. This arm can be optionally telescoping as well to facilitate adjustment and/or storage.

The total height of the target is preferably such that the target surface can be easily and directly viewed by the driver of the towing vehicle while operating the vehicle (e.g., through the rear window). Of course, the height or length of the target depends on the length of the first and second arm, the angle of the joint and the dimensions of the target surface. It is preferred that the total length of the target, when expanded, is at least the distance between the top surface of the mating component and the center of the rear window on the tow vehicle, whether it be an automobile or truck. A target with an adjustable height can be adjusted to range between the distance from the mating component and the center of the rear window of a small car or a large truck. Preferably the length of the second adjustable arm will be less than 6 inches and the length of the first adjustable arm can be adjustable to be usable for both a small car and a large truck.

The target surface reflects the beam of light and, preferably, presents markings [42] (e.g., a cross-hair) which easily indicate that the mating components are aligned. A preferred embodiment of the invention will have a backing plate [35] affixed directly to the adjustable joint [6] rather than the optional second arm [5]. This preferred embodiment will also have a metal target surface [7] (such as aluminum or stainless) that provides high contrast to the beam of light [24]. This metal target surface [7] is preferably affixed to the backing plate [35] by a rivet or other suitable loose fastener that will allow the target surface [7] to pivot for folding.

Alternatively, a cloth or other flexible target surface [7] can be used which comprises a collapsible internal frame [26] to facilitate storage.

The target surface [7] can preferably be approximately 18 inches or less in diameter, width and/or height. The target surface [7] can be any two dimensional shape, such as a rectangle, circle or triangle. In the triangular configuration, the internal frame can be comprised of two rigid or semi-rigid surface arms connected to each other by a spring which, when released, causes the target surface to open. Other configurations can be readily envisioned.

Bumper ball type hitching mechanisms typically comprise a ball mounted either to the bumper or to a sub-frame at or near the level of the bumper on the tow vehicle [1], and a locking socket to receive the ball affixed to the forward-most point of the trailer [2] frame. The two components [25] are aligned and may be mated when both vertical axis [27][28] pass through the center of both the ball and socket.

Gooseneck type hitching mechanisms typically comprise a ball mounted on the truck bed itself or on a vertically-extended bumper sub-frame, and a locking socket to receive the ball affixed to the forward-most point of the trailer [2] frame. The two components [25] are aligned and may be mated when both vertical axis [27][28] pass through the center of both the ball and socket.

A preferred method of aligning the mating components [25] of bumper ball, or gooseneck hitching mechanisms comprises:

a) Providing a trailer [2] wherein the target [15] is mounted on top of the mating component [25] such that the vertical axis [28] passes through the center of the target mount [3] and the adjustable arm [4];

b) Affixing the light emitting device [8] to the front edge of the trailer mating component [25] using one of the magnets [31] attached to the bracket [32];

c) Adjusting the target surface [7] so that the beam of light [24] from the light emitting device [8] is centered on the target surface [7];

d) Providing a tow vehicle [1] where the light emitting device [8] is affixed on top of the mating component [25] using one of the magnets [31] attached to the bracket [32] and in such a manner that the vertical axis [27] passes through the center of the magnet [31];

e) Positioning the tow vehicle [1] so that the rear end [21] of the vehicle is adjacent to the front end [16] of the trailer [2];

f) Maneuvering the vehicle [1] so that the beam of light [24] is centered on the target surface [7] to indicate the alignment of the mating components [25].

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

What is claimed is:

1. An apparatus capable of aligning mating components [25] used to secure a trailer [2] to a tow vehicle [1], the apparatus comprising:
a) a light emitting device [8] comprising:
a. a light source capable of projecting a beam of visible light [24]; and
b. a mount [10] which can be attached to the tow vehicle [1] or its mating component; and
b) a target [15] comprising:
a. a mount [3] attached to the trailer [2] or its mating component;
b. an adjustable arm [4] affixed to the mount [3] at one end;
c. an adjustable joint [6] affixed to the adjustable arm [4] at a point distal to the mount [3];
d. an optional second arm [5] affixed to the adjustable joint [6]; and
c) a target surface [7] which is affixed to either the second arm [5] or the adjustable joint [6].

2. The apparatus of claim 1 wherein the mount [10] of the light emitting device [8] comprises:
a. one or more magnets [31];
b. a gimbal ring [30] to provide self-leveling capability to the light emitting device [8];
c. a bracket [32] to support the magnets [31] and the gimbal ring [30].

3. The apparatus of claim 1 wherein the target mount [3] comprises a magnet.

4. The apparatus of claim 1 wherein the target mount [3] comprises an adjustable band [33].

5. The apparatus of claim 1 wherein the target mount [3] comprises a non-slip coating [34].

6. The apparatus of claim 1 wherein the light emitting device [8] comprises a laser.

7. The apparatus of claim 6 wherein the laser emits a continuous beam of light [24].

8. The apparatus of claim 1 further comprising a remote control operably linked to the light emitting device [8].

9. The apparatus of claim 1 wherein the adjustable arm [4] of the target [15] is telescoping.

10. The apparatus of claim 1 wherein the adjustable arm [4] comprises marks that identify preset heights.

11. A method of aligning the mating components of bumper ball or gooseneck hitching mechanisms used to secure a trailer 2 to a tow vehicle 1, the method comprising:
a) providing a trailer [2] wherein the target [15] is mounted on top of the mating component [25] such that the vertical axis [28] passes through the center of the target mount [3] and the adjustable arm [4];
b) affixing the light emitting device [8] to the front edge of the trailer mating component [25] using one of the magnets [31] attached to the bracket [32];
c) Adjusting the target surface [7] so that the beam of light [24] from the light emitting device [8] is centered on the target surface [7];
d) Providing a tow vehicle [1] where the light emitting device [8] is affixed on top of the mating component [25] using one of the magnets [31] attached to the bracket [32] and in such a manner that the vertical axis [27] passes through the center of the magnet [31];
e) positioning the tow vehicle [1] so that the rear end [21] of the vehicle is adjacent to the front end [16] of the trailer [2];
f) maneuvering the vehicle [1] so that the beam of light [24] is centered on the target surface [7] to indicate the alignment of the mating components [25].
